(19) United States
(12) Patent Application Publication
(10) Pub. No.: US 2014/0367466 A1
(43) Pub. Date: Dec. 18, 2014

(54) CHECKOUT KIOSK

(71) Applicant: MOTOROLA SOLUTIONS, INC., Schaumburg, IL (US)

(72) Inventors: MADHUSUDAN K. PAI, BANGALORE (IN); AROON V. TUNGARE, WINFIELD, IL (US); YI WEI, ST. JAMES, NY (US)

(21) Appl. No.: 13/916,010

(22) Filed: Jun. 12, 2013

(51) Int. Cl. G06Q 30/06; G06K 7/10

(52) U.S. Cl. CPC G06Q 30/0641; G06K 7/10861
USPC 235/383; 235/462.13

(57) ABSTRACT

A checkout kiosk employing a transparent touch-screen surface is provided herein. More particularly, the checkout kiosk comprises a transparent, force-sensing layer on top of a bar code reader or imaging camera. The force-sensing layer is used to capture both a weight and a weight distribution of an object placed on its surface. During operation, the touch-screen surface will be used to weigh any item and obtain a “foot print” of the item. A barcode scanner and an optional camera are provided below the touch-screen surface and will image through the touch screen in order to obtain identification information on the product. The weight, barcode scan, footprint, and image of the product may all be used to aide in identifying the product.

### FIELD OF THE INVENTION

The present invention generally relates to checkout kiosks, and more particularly to a checkout kiosk employing a transparent touch-screen surface used for product identification.

### BACKGROUND OF THE INVENTION

Checkout kiosks are ubiquitous in retail stores. Whether these kiosks are self-checkout kiosks or employee-assisted kiosks, the purpose of these kiosks is to ultimately identify a product and determine the price of the product. Many times a checkout kiosk is unable to properly identify an item for purchase. This results in a delayed checkout process, which can be very frustrating to employees and customers alike. Therefore a need exists for a checkout kiosk that reduces instances of unidentified products.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a checkout kiosk.

FIG. 2 is a block diagram of a configuration of the checkout kiosk of FIG. 1.

FIG. 3 is a block diagram of the scale of FIG. 1 and FIG. 2.

FIG. 4 illustrates pressure being applied to the scale of FIG. 1 and FIG. 2.

FIG. 5, FIG. 6, and FIG. 7 are a more-detailed block diagram of the scale of FIG. 1 and FIG. 2.

FIG. 8 is a flow chart showing operation of the kiosk of FIG. 2.

FIG. 9 is a flow chart showing operation of the kiosk of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a checkout kiosk employing a transparent touch-screen surface is provided herein. More particularly, the checkout kiosk comprises a transparent, force-sensing layer on top of a bar code reader or imaging camera. The force-sensing layer is used to capture both a weight and a weight distribution of an object placed on its surface. During operation, the touch-screen surface will be used to weigh any item and obtain a “foot print” of the item. A barcode scanner and an optional camera are provided below the touch-screen surface and will image through the touch screen in order to obtain identification information on the product. The weight, barcode scan, footprint, and image of the product may all be used to aide in identifying the product.

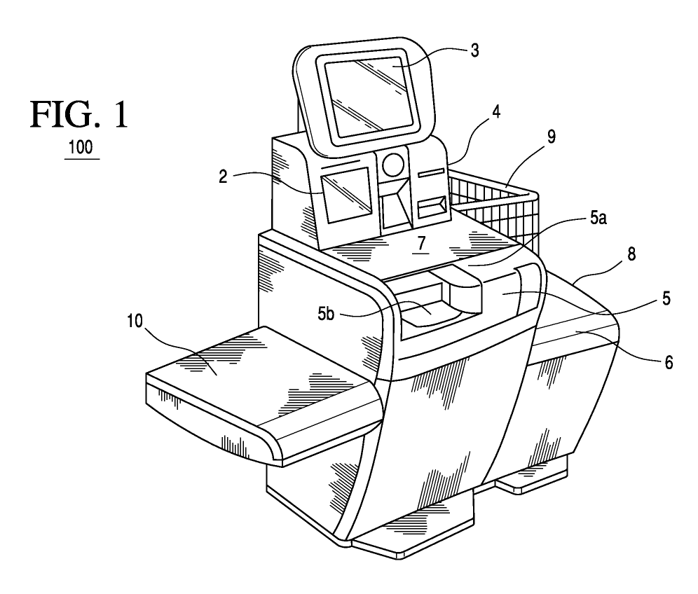

FIG. 1 is a block diagram of a checkout kiosk 100. Kiosk 100 includes a scanner unit 2 (a reading unit), a display 3, a receipt printer 4, a change dispensing machine 5, a first weighing scale 6, and a second weighing scale 7. The scanner unit 2 reads a data code, for example, a barcode attached to a commodity. The display 3 displays commodity names, unit prices, numbers, a total amount, a change amount, and the like of commodities during registration and settlement processing for the commodities. A touch panel is provided on a display screen of the display 3. The receipt printer 4 prints out the commodity names, the unit prices, the numbers, the total amount, the change amount, and the like on a receipt sheet. The change dispensing machine 5 dispenses change during settlement processing. The change dispensing machine 5 includes a coin input port 5a and a change take-out port 5b. The first weighing scale 6 is provided on a packing table 8 and is used to determine if a product was placed onto packing table 8. When a shopping basket 9 or the like containing commodities is placed on the packing table 8, the weighing scale 6 detects, according to the weight of the shopping basket 9 or the like, that the shopping basket 9 or the like is placed. Second weighing scale 7 is used to determine the weight of a purchased produce, for example, when a product is priced by weight. The packing table 8 is provided on one side of a terminal main body. A basket placing table 10 is provided on the other side.

Although not shown in FIG. 1, a second scanning unit (barcode scanner) is located under scale 7. The second scanner unit is a standard laser barcode scanner that is capable of lasing a barcode through transparent scale 7. Additionally, although not shown in FIG. 1 camera may be located under scale 7 in order to image any products and aide in identifying the products.

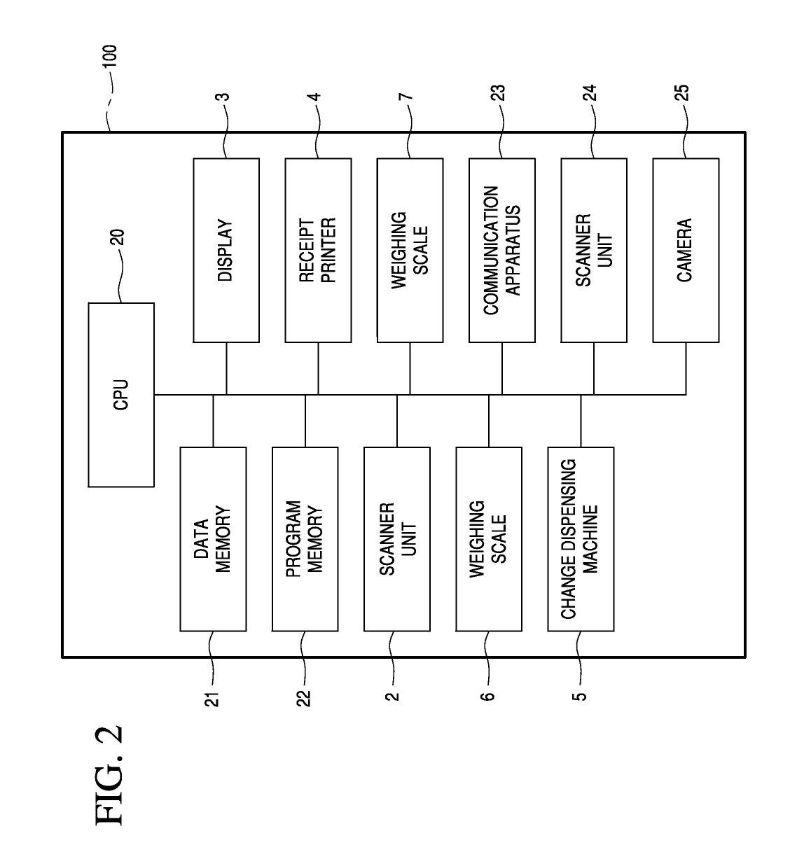

FIG. 2 is a block diagram of a configuration of the checkout kiosk of FIG. 1. Kiosk 100 comprises a central processing unit (CPU) 20. CPU 20 preferably comprises logic circuitry such as a digital signal processor (DSP), general purpose microprocessor, a programmable logic device, or application specific integrated circuit (ASIC) and is utilized to accesses and control all hardware/software within kiosk 100. The scanner unit 2, the display 3, the receipt printer 4, the change dispensing machine 5, the weighing scale 6, and the weighing scale 7 are connected to the CPU 20. Further, a data memory 21, a program memory 22, a communication apparatus 23, scanner unit 24, and camera 25 are connected to the CPU 20.

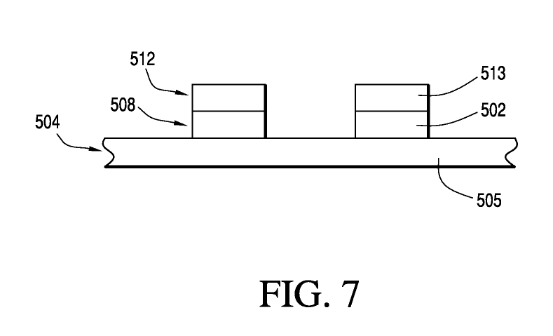

The data memory (database) 21 temporarily stores, for example, data during registration and settlement processing for commodities. Database 21 also stores reference footprints so that items placed on scale 7 may have their weight and shape referenced with those in database 21 in order to aide in identification. In the program memory 22, various control programs executed by the CPU 20 are stored in advance. The communication apparatus 23 performs data communication between the kiosk 100 and an external apparatus. The CPU 20 executes the control programs stored in the program memory 22 to realize the functionality shown in FIG. 8.

As discussed above, many times a checkout kiosk is unable to properly identify an item for purchase. This results in a delayed checkout process, which can be very frustrating to employees and customers alike. Therefore a need exists for a checkout kiosk that reduces instances of unidentified products. In order to address this issue, scale 7 comprises a transparent force sensing layer capable of detecting the weight and weight distribution (or profile), of an item along with the items footprint. Thus, scale 7 comprises a transparent force-sensing layer that is capable of determining both the shape and weight of object.

Using a force-sensing touch screen, CPU 20 can determine a weight profile and a shape profile of the object depending on how it rests on the force sensing touch screen 7. For example, a user at a hardware store can place a bolt on the touch interface. Since each bolt will have a unique shape and weight profile, the part can be uniquely identified via referencing a database 21 along with any attached barcode. Thus, unlike prior-art scales at kiosks which are mechanical in nature and require a special glass window for scanner 24 and camera 25 to function, scale 7 is fully transparent.

While the disclosed method will work with any transparent force sensing touch-screen technology, it is uniquely suited with the utilization of the technology disclosed in US Pub. No. 20090237374, entitled TRANSPARENT PRESSURE SENSOR AND METHOD FOR USING, and incorporated by reference herein. Thus, utilizing the technology disclosed in the '374 publication, scale 7 has a transparent force sensing (TFS) layer which detects changes in resistivity due to applied force. When an object is placed on a scale 7, the weight of the object results in a change in resistivity of the TFS and this delta in resistivity (with and without the object) can be used to detect the weight of the object. The TFS layer can be customized for different force levels. So devices could be built with different TFS composition/size depending on the range of weight to be measured.

Since scale 7 also supports multi-touch, a profile of an object placed on the scale 7 pad can be generated (force on each pixel touched by the object). The profile can be compared against reference profiles to determine the identity of an object placed on the scale 7.

Since scale 7 provides a transparent, distributed, force sensing layer, such layer can be attached to the exit window of a scanner 24 and the object bar code can be scanned through the scale while at the same time weighing the object. In fixed devices that use the above technique, the scale 7 surface can be mounted horizontally (as part of construction of the device). In mobile devices, additional sensor input (e.g. accelerometer) may be used to inform the user to place the device horizontally or use the angle of inclination with the normal (vertical) in the weight computation.

In a similar manner, since scale 7 provides a transparent, distributed, force sensing layer, such layer can be attached to the exit window of a camera 25 and the object placed on scale 7 can be imaged through the scale, while at the same time weighing the object.

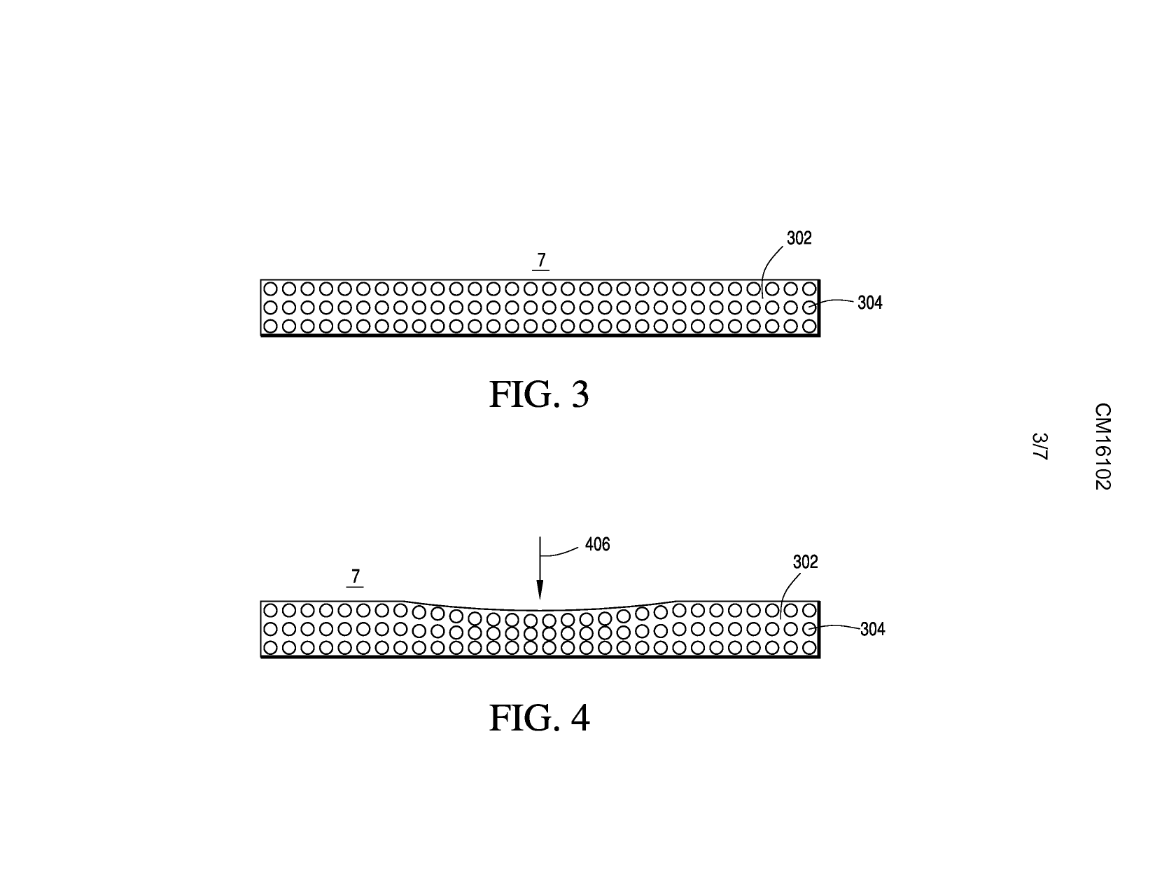

FIG. 3 is a block diagram of scale 7. Scale 7 comprises a transparent matrix 300 that includes a material 302 including at least one polymer. For example, the material 302 may comprise a transparent elastomeric matrix such as polyester, phenoxy resin, polyimide, or silicone rubber. Transparent conductive or semiconductive particles 304 such as indium tin oxide, zinc oxide, or tin oxide dispersed within the material 302.

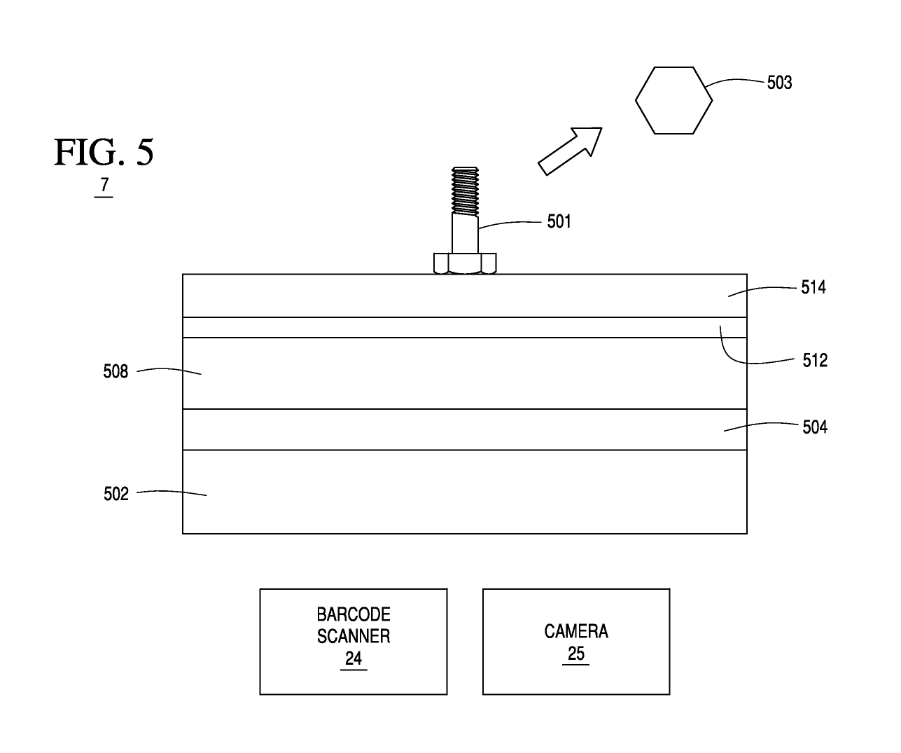

When pressure is applied to scale 7 in a direction 406 (FIG. 4), scale 7 is compressed, reducing the distance between adjacent particles 304 as well as the conductive path between electrodes (not shown), thereby lowering the resistance. Current flows through the material 302 and through the particles 304, either directly through the particles 304 when the particles 304 are in contact with each other, or by tunneling through the material 302 when the particles 304 are separated by a very small distance.

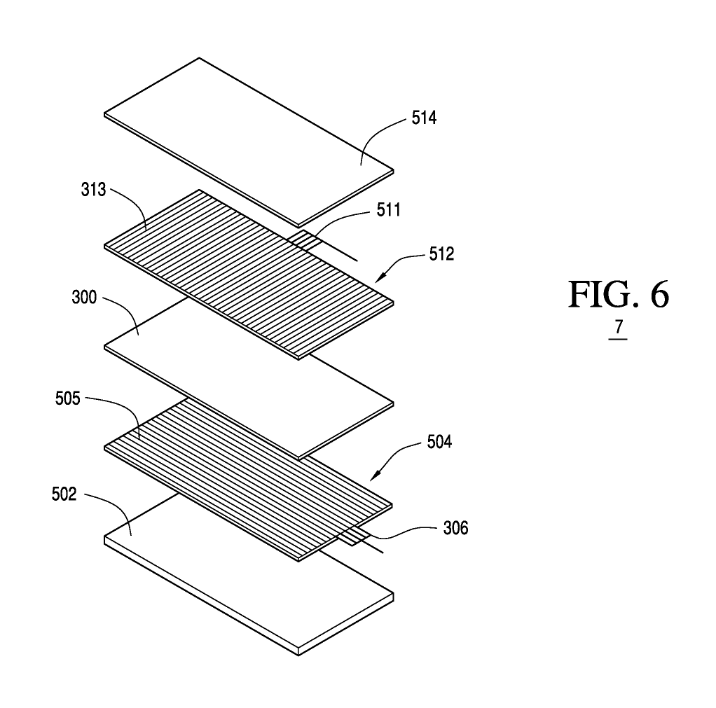

Referring to FIG. 5 and FIG. 6, a transparent scale 7 includes a transparent substrate 502 preferably is a rigid material of, for example, glass or a polymer, but may be a flexible material. A patterned layer 504 of transparent conductive traces 505 is deposited on the substrate 502. The traces 505 are preferably aligned in a first direction and have a pitch of 0.05-10 mm, (preferably 0.75 mm), a width less than the pitch but larger than 0.001 mm, a thickness of 1.0-3000 nm, (preferably 80 nm). The transparent traces 505 may be a transparent conductive oxide, for example, indium tin oxide, zinc oxide, and tin oxide. A tab 506 is electrically coupled to each trace for providing connection to other circuitry as is known in the industry.

Transparent scale 7 is disposed on the traces 505 as a layer or in a predetermined pattern. The transparent material 502 preferably is a transparent elastomeric matrix such as polyester, phenoxy resin, or silicone rubber. Transparent conductive or semiconductive particles 504 such as indium tin oxide, zinc oxide, or tin oxide.

A patterned layer 512 of transparent conductive traces 513 is deposited over the layer 508 of the transparent scale 7. The placement of the transparent conductive traces 513 creates a plurality of intersections, each including one of the transparent conductive traces 513, conductive traces 505 (FIG. 6). The layer 508 may be patterned to form a plurality of islands 502, with each island formed between an intersect of the transparent conductive traces 505 and 513 (FIG. 7). Finally, an optional layer 514 of a transparent protective material, such as glass or a polymer, is disposed over the patterned layer 512. As shown, barcode scanner 24 and/or an optional camera 25 is shown lying below scale 7 and imaging/scanning an object through scale 7. In this particular example, bolt 501 is imaged along with a bar code (not shown) attached to bolt 501.

When pressure is applied to the transparent scale 7 by applying pressure to the layer 514, the scale 7 is compressed, reducing the distance between adjacent particles 504 as well as the conductive path, thereby lowering the resistance between conductive traces 505 and 513. Current flows through matrix 300 and through the particles 504, either directly when the particles 504 are in contact with each other, or by tunneling through the scale 7 when the particles 504 are separated by a very small distance. In addition to a weight being obtained, scale 7 can obtain a footprint, or shape profile of the object as it makes contact with, or sits upon, scale 7. This is shown as footprint 503.

As is evident, the kiosk described above allows a barcode scanner and a camera to be placed directly under scale 7, and image through scale 7 without the need for a special window existing within scale 7. With this in mind, during operation of kiosk 100, an item is placed on scale 107. Logic circuitry 20 will activate all scanners 2 and 24 to read any barcode existing on the product. Logic circuitry 20 will obtain a weight of the item from scale 7. Logic circuitry may additionally obtain a footprint of the item from scale 7. Finally, logic circuitry may optionally obtain an image of the product through camera 25. This information will aide in determining an identity of the product.

FIG. 8 is a flow chart showing operation of the kiosk of FIG. 2. The logic flow begins at step 801 where scale 7 detects that an item has been placed on its surface. This information is provided to CPU 20 and in response, CPU 20 obtains the weight of the item (step 803) and:
instructs scanner units 2 and 24 to scan the item for a barcode and provide CPU 20 barcode information (step 805);
instructs camera 25 to provide CPU 20 an image the item (this step is optional) (step 807);
instructs instruct scale 7 to obtain and provide a footprint of the item (this step is optional) (step 809).

At step 811 the obtained information is used by CPU 20 to identify the product. As described above, this is accomplished by CPU accessing database 21 and its stored library of product information. More particularly, bar code information, shape information, weight information, and image information may all be used and compared with such information stored in database 21.

Once the product has been identified, normal checkout procedures take place. For example, the identification and price may be displayed on display 3 and added to items purchased by the user.

With the above in mind, the present invention provides for an apparatus that comprises a scale having a force-sensing transparent surface and at least a bar-code scanner positioned below the force-sensing transparent surface and aimed to scan bar codes through the force-sensing transparent surface. An optional camera may be positioned below the force-sensing transparent surface and aimed to image products through the force-sensing transparent surface. As described above, the scale preferably comprises a transparent force sensing (TFS) layer which detects changes in resistivity due to an applied force.

A database is provided that comprises a library of product identifiers (i.e., identification information on products for sale). Thus, logic circuitry can receive a weight of an item along with bar-code information, and access the database to aide in identifying a product.

A camera may be positioned below the force-sensing transparent surface and aimed to image products through the force-sensing transparent surface. With this in mind, the logic circuitry additionally can receive an image from the camera and use the image to aide in identifying the product. Image data may be kept in the database.

Finally, the logic circuitry can additionally receive a footprint of the product from the scale and use the footprint to aide in identifying the product. Footprint data may be kept in the database.

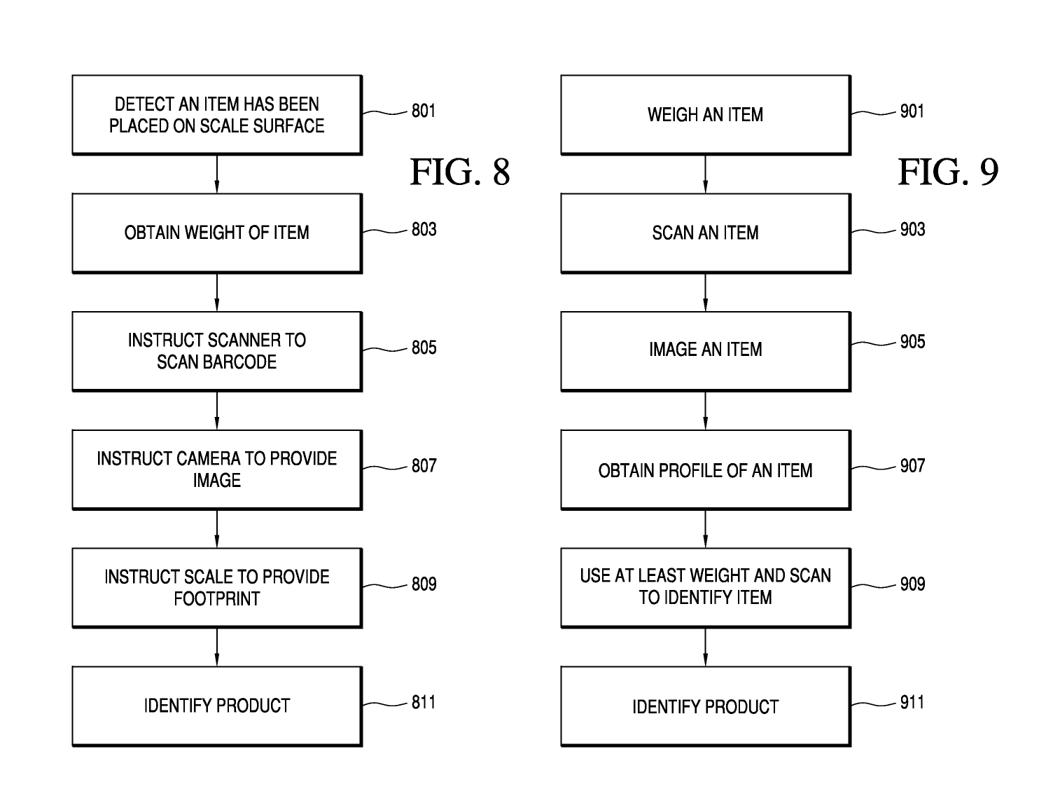

All of the above may be placed within a checkout kiosk that can be operated as shown in FIG. 9. At step 901, the checkout kiosk weighs an item for sale placed on a transparent, force-sensing surface. A bar code is scanned through the transparent, force-sensing surface (step 903) and the bar code and weight are used in identifying an item for sale (step 909).

Optionally, the item for sale may be imaged with a camera directed to take an image through the force-sensing surface (step 905), with the image an image of the item for sale is being used in addition to the weight and the bar code information to identify the item for sale in step 909. Finally, an optional footprint of the item as it rests on the scale may be obtained (step 907), with the footprint of the item being used in addition to the weight and bar code information to identify the item for sale.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a scale having a force-sensing transparent surface;
a bar-code scanner positioned below the force-sensing transparent surface and aimed to scan bar codes through the force-sensing transparent surface.

2. The apparatus of claim 1 further comprising:
a camera positioned below the force-sensing transparent surface and aimed to image products through the force-sensing transparent surface.

3. The apparatus of claim 1 wherein the scale comprises a transparent force sensing (TFS) layer which detects changes in resistivity due to an applied force.

4. The apparatus of claim 1 further comprising:
a database comprising a library of product identifiers;
logic circuitry receiving a weight of an item and receiving bar-code information, and accessing the database to aide in identifying a product.

5. The apparatus of claim 4 wherein the scale comprises a transparent force sensing (TFS) layer which detects changes in resistivity due to applied force.

6. The apparatus of claim 4 further comprising:
a camera positioned below the force-sensing transparent surface and aimed to image products through the force-sensing transparent surface; and
wherein the logic circuitry additionally receives an image from the camera and uses the image to aide in identifying the product.

7. The apparatus of claim 4 wherein:
the logic circuitry additionally receives a footprint of the product from the scale and uses the footprint to aide in identifying the product.

8. A checkout kiosk comprising:
a scale having a force-sensing transparent surface providing a weight and shape profile of an item;
a bar-code scanner positioned below the force-sensing transparent surface and aimed to scan bar codes through the force-sensing transparent surface
a database comprising a library of product identifiers;
logic circuitry receiving the weight and shape profile of the item from the scale and receiving bar-code information from the bar-code scanner and accessing the database to aide in identifying the item.

9. The checkout kiosk of claim 8 further comprising:
a camera positioned below the force-sensing transparent surface and aimed to image products through the force-sensing transparent surface;
wherein the logic circuitry additionally receives an image from the camera and uses the image to aide in identifying the item.

10. The checkout kiosk of claim 1 wherein the scale comprises a transparent force sensing (TFS) layer which detects changes in resistivity due to applied force.

11. A method comprising the steps of:
weighing an item for sale placed on a transparent, force-sensing surface;
bar-code scanning an item through the transparent, force-sensing surface;
using the weight and bar code information to identify an item for sale.

12. The method of claim 11 further comprising the step of:
imaging the item for sale with a camera directed to take an image through the force-sensing surface;

13. The method of claim 12 wherein the image an image of the item for sale is used in addition to the weight and the bar code information to identify the item for sale.

14. The method of claim 12 further comprising the step of:
obtaining an footprint of the item for sale as it rests on the scale;

15. The method of claim 14 wherein the footprint of the item is used in addition to the weight and the bar code information to identify the item for sale.
